(19) United States
(12) Patent Application Publication
(10) Pub. No.: US 2020/0072485 A1
(43) Pub. Date: Mar. 5, 2020

(54) Devices, Systems and Method for Monitoring and Responding to Environmental Conditions

(71) Applicant: DISH Network L.L.C., Englewood, CO (US)

(72) Inventor: Jerome A. LaPalme, Aurora, CO (US)

(73) Assignee: DISH Network L.L.C., Englewood, CO (US)

(21) Appl. No.: 16/116,201

(22) Filed: Aug. 29, 2018

(51) Int. Cl. F24F 11/33; H04L 29/08; H04Q 9/02; G05B 19/042; F24F 11/00; F24F 11/65

(52) U.S. Cl. CPC F24F 11/33; H04L 67/12; H04Q 9/02; H04W 4/38; F24F 11/0001; F24F 11/65; H04Q 2209/886; G05B 19/0428

(57) ABSTRACT

The various embodiments of the present disclosure relate to devices, systems, and methods for use in monitoring and responding to roof temperature and/other environmental conditions. A monitoring system may include a first sensor configured to monitor a first condition of a given structure. A first communications device may be coupled to the first sensor and configured to output a first message providing a status of the structure. The first communications device may be configured to output the first message using a narrow band Internet of Things (NBIoT) communications topology. A remote control system may be communicatively coupled to the first communications device and configured to analyze the first message and based thereon take a first action. The monitoring system may include a remote control system that is directly communicatively coupled to the first communications device via NBIoT. The monitoring system may execute activate a thermal regulation device.

### TECHNICAL FIELD

The technology described herein generally relates to devices, systems, and methods for monitoring environmental conditions of structures. More specifically, the technology described relates to monitoring temperatures of roofs and other sun exposed surfaces. The technology described herein also relates to devices, systems and methods for responding to roof temperature and other sun exposed surface temperature conditions. The technology described herein also generally relates to the use of temperature monitoring devices that are connected to one or more networks using narrow band Internet-Of-Things (IOT) and/or other communications technologies. The technology described also relates to the monitoring of environmental conditions, such as rain, hail, wind or otherwise, as such conditions impact and/or effect one or more portions of a structure, vehicle, foliage or other feature of a given landscape.

### BACKGROUND

Today, elevated temperatures on roofs of buildings and/or other sun exposed surfaces (herein, each a “sun surface”) can cause undesired and/or deleterious effects on other portions of a structure or assembly thermally coupled to the sun surface. Examples of such other structures or assemblies (herein, each a “structure”) which are thermally coupled include, but are not limited to, building attics, interior compartments of buildings, electronic and/or electrical devices, such as solar panels positioned on sun surfaces, vehicle interiors, or otherwise. It is to be appreciated that such thermal coupling between a sun surface and a structure may occur by way of convection, conduction, radiation, or otherwise. Examples of undesired effects include, but are note limited to, interior temperatures rising above a desired threshold, expansion concerns, melting, warping, impacts upon plants, animals and/or humans, and otherwise. Yet, devices, systems and methods for monitoring and responding to temperatures of sun surfaces are not readily available. While thermometers and the like commonly exist, such devices typically monitor the temperature of an area and are typically not designed to monitor temperatures of individual sun surface area and/or a sub-area or sub-assembly thereof. Further, while various devices exist which enable a person or system to respond to elevated temperatures within a structure, such systems are typically reactive and are often engaged after the ambient temperature in a structure exceeds a given threshold, such as when an interior of a home exceeds a pre-set threshold. Such reactive systems often result in temperature swings between those above a given threshold and those below a given threshold, with the reactive system being repeatedly engaged and disengaged, and often in an inefficient manner. Accordingly, a need exists for devices, systems and methods for monitoring temperatures of sun surfaces and responding proactively to temperatures changes of sun surfaces before the impact of such changes in the temperature of a sun surface occurs upon a structure.

### SUMMARY

The various embodiments of the present disclosure relate in general to devices, systems, and methods for use in monitoring and responding to roof and/other sun surface temperature conditions and/or other conditions, such as hail, wind, rain or otherwise. In accordance with at least one embodiment of the present disclosure, a monitoring system may include a first sensor configured to monitor a first condition of a given structure. A first communications device may be communicatively coupled to the first sensor and configured to output a first message providing a status of the given structure. For at least one embodiment, the first communications device may be configured to output the first message using a narrow band Internet of Things communications topology.

For at least one embodiment, a monitoring system may include a remote control system, communicatively coupled to the first communications device, configured to analyze the first message and based thereon take a first action. The monitoring system may include a remote control system that is directly communicatively coupled to the first communications device via the narrow band Internet of Things communications topology. The monitoring may include a first sensor and a first communications device which are configured into a single integrated device. The monitoring system may include executing a first action that includes activation of a thermal regulation device. The monitoring system may include use a first sensor that includes a temperature sensor such that a first condition monitored is a temperature of a portion of the given structure. The monitoring system may be used where a portion of the given structure is a tile of a roof of a building.

For at least one embodiment, a monitoring system may include a second sensor configured to monitor a second condition of a second structure. The monitoring system may include a second communications device, communicatively coupled to the second sensor, configured to output a second message using the narrow band Internet of Things communications topology. The monitoring system may include a remote control system, communicatively coupled to each of the first communications device and the second communications device, configured to analyze the first message and the second message and based thereon take a second action. For at least one embodiment, the second structure may be a solar panel mounted on the given structure. For at least one embodiment, a second condition may include an electrical output of the solar panel, and a second message may provide an indication of the electrical output of the solar panel. For at least one embodiment, the second action may include generation of an alert message when the electrical output of the solar panel is less than an expected electrical output in view of the first condition of the given structure. For at least one embodiment, a first condition may indicate a rising temperature of a roof portion of a given structure. The roof portion and the second structure may be located on the given structure so as to have a substantially similar sun impact angles.

For at least one embodiment of the present disclosure, a local control system may be used in a monitoring system. The local control system may be communicatively coupled to a first communications device, configured to analyze the first message and based thereon take a first action. For at least one embodiment, a first action may include configuring an operating state of at least one of an active thermal regulation device and a passive thermal regulation device. For at least one embodiment, an operating state of an active thermal regulation device includes an on state and an off state and an operating state of a passive thermal regulation device may include an open state and a closed state.

For at least one embodiment of the present disclosure, a monitoring system may include an active thermal regulation device, such as an attic fan configured, when in the on state, to vent an attic of a given structure. A passive thermal regulation device may include an attic vent, configured, when in the open state, to permit venting of an attic of a structure. For at least one embodiment, the monitoring system may include a remote control system, communicatively coupled to the first communications device, configured to analyze the first message and based thereon take a second action.

For at least one embodiment of a monitoring system for use in accordance with the present disclosure, a first sensor may include a temperature sensor and a first condition may include a temperature of a roof portion of the given structure. The first message may be periodically output by a first communications device as the temperature of the roof portion of the given structure changes. A second action may occur in view of such changes and may include communicating at least one alert message to an occupant of the given structure. The at least one alert message may indicate that a third action is being implemented by the local control system in view of a current temperature of the roof portion of the given structure as reported in a currently received first message. The remote control system may be configured to instruct the local control system to implement the third action. The third action may involve one of activation or deactivation of an HVAC system for the given structure.

In accordance with at least one embodiment of the present disclosure, a method for monitoring progression of a forest fire may include deploying a plurality of sensors proximate to a forest fire. Each of the plurality of sensors may be configured to read and report on a current environmental condition. The method may also include deploying at least one receiving station and monitoring, at a remote control system, each report of the current environmental condition by each of the plurality of sensors. Each of the plurality of sensors may include and/or have access to a narrow band Internet-of-Things communications capability. The plurality of sensors may be communicatively coupled to the at least one receiving station using the narrow band Internet-of-Things communications capability. The at least one receiving station may be communicatively coupled to the remote control station a and, based on reported current environmental readings reported by each of the plurality of sensors, the remote control station may predict future progression of the forest fire. The environmental condition may indicate at least one of a current temperature, dew point, humidity, and moisture content of a given portion of a landscape proximate to the forest fire.

In accordance with at least one embodiment of the present disclosure, an Internet-of-Things device may include a first sensor configured to monitor a first condition. The device may include a first communications device configured to report the first condition to at least one of remote control system and a local control system. The first communications device may be configured to report the first condition using a narrow band Internet-of-Things communications technology. The first condition may include a temperature of a portion of a roof for a given structure. The first sensor may include a temperature sensor. The first condition may include a temperature reading by the first sensor that exceeds a given threshold. For at least one embodiment, an Internet-of-Things device may include a second sensor configured to monitor a second condition. The second condition may include an impact of an object upon the portion of the roof for the given structure. The first communications device may be further configured to report the second condition to the remote control system for further reporting of the second condition by the remote control system in an alert message when the monitored second condition exceeds a given threshold.

### BRIEF DESCRIPTION OF THE DRAWINGS

The features, aspects, advantages, functions, modules, and components of the devices, systems and methods provided by the various embodiments of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When only the first reference label is used in the specification, the description is applicable to any of the similar components and/or views having the same first reference number irrespective of any additional alphabetic designators or second reference labels, if any.

FIG. 1 is schematic representation of a system for use in monitoring and/or responding to sun surface temperature conditions and in accordance with at least one embodiment of the present disclosure.

### DETAILED DESCRIPTION

The various embodiments described herein are directed to devices, systems, and methods for use in monitoring and responding to sun surface temperature conditions. As used herein, a “sun surface” is any surface that is positioned and/or configured to be exposed to and thereby receives energy radiated by the sun (“solar radiation”). Such a sun surface may be configured to be permanently exposed to receive solar radiation, such as a roof of a building, or may be configured to be intermittently exposed to receive solar radiation, such as a louvre on a building, an adjustable solar panel, a car or recreational vehicle (RV) parked in an open lot, or otherwise. A sun surface may be configured to receive some of the solar radiation, while reflecting other portions of the solar energy. Further, the solar radiation may occur in either direction such as during one or more daylight hours when solar radiation travels through the earth's atmosphere and onto the sun surface, or during one or more non-daylight hours, such as when thermal energy is redirected, by means of convection, by a sun surface back itself into the atmosphere, as may occur during night time hours.

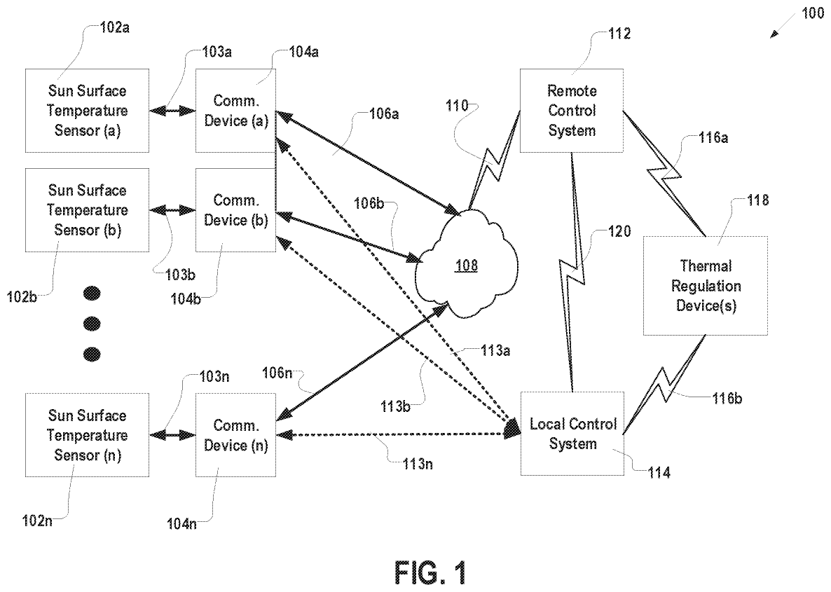

As shown in FIG. 1 and for at least one embodiment of the present disclosure, a system 100 may include one or more sun surface temperature sensors 102a/102b/102n. One or more of the sun surface temperature sensors 102 may be configured to be provided within and/or in conjunction with a “member” (not shown) of a given sun surface (not shown). An example of a sun surface may include a roof of building. A member of such a roof sun surface may include one or more roof tiles. It is to be appreciated that such roof tiles may come in various forms and be made of various materials, each of which are well known in the art and include, for example, asphalt shingles, ceramics tiles, concrete tiles, and otherwise. Other forms of sun surface may exist, such as solar panels, RV roofs, car roofs, building windows, building siding and otherwise. The present disclosure is not limited to any particular size, function, form, material, solar aspect angle, or otherwise.

Further, a sun surface temperature sensor 102 may be configured to be provided on any surface of the member, such as above, below, within or otherwise. For at least one embodiment, a sun surface temperature sensor 102 is configured to not directly receive solar radiation. Further, the sun surface temperature sensor 102 may include a single contact point, at which a then arising temperature of the member is monitored, multiple contact points, such as may be provided by use of one or more of an array of extending thermocouple elements, or otherwise. Further, it is to be appreciated that the sun surface temperature sensor 102 may utilize any known or later arising technology to determine a then existing temperature of a member, such technologies, may use, for example, convection, conduction, radiation, or otherwise and may be measured physically, electromagnetically, or otherwise. Further, for at least one embodiment, an array of sun surface temperature sensors (herein after, each a “sensor”) may be used to monitor one or more areas of a sun surface. Readings from such one or more sensor(s) may be monitored individually, collectively or otherwise. Further, readings from such one or more sensors may be monitored over any desired time interval, such as continually, periodically, on a given schedule (such schedule being pre-determined or random, as based upon detected changes in temperatures over a given time), or otherwise. Further, a sun surface temperature sensor 102 may be configured as a passive device, wherein the sensor merely reports out temperatures on a given, pre-set time interval, or as an active device that can be adjusted, as desired, to provide temperature reading outputs on any given basis or interval, including a then arising or then occurring basis. For at least one embodiment, a sensor 102 may be configured to provide average, instantaneous, past or other temperature readings. When so configured, the sensor 102 may include data processing and storage elements within the sensor itself. In other embodiments, such data processing and/or storage elements may be provided by other components of the system 100.

As further shown in FIG. 1, the system may include one or more first links 103a/103b/103n which are configured to electrically and/or communicatively couple one or more sensors 102 to one or more communications devices 104a/104b/104n. As shown, a communications device 104 may be provided for each sensor 102. In other embodiment, one or more sensors 102 may be coupled collectively to a given communication device 104. The first link(s) 103 couple sensor(s) 102 to communications device(s) 104 using any desired technology. For at least one embodiment, a sensor 102 may be electrically coupled to a given communications device 104 by one or more electrical wires. For another embodiment, a sensor 102 may include narrow band communications capabilities or other wireless communications capabilities, and may be connected to the communications device 104 using a radio frequency signal. In at least one embodiment, a wireless narrow band Internet-of-Things (NBIoT) communications link may be utilized to connect one or more sensor(s) 102 to one or communications device(s) 104. It is to be appreciated that with a use of NBIoT communications technologies with the first link 103, sensors 102 may be configured to use very little energy to transmit and/or receive communications signals to and from a given communications device 104. For at least one embodiment, the electrical energy needed to facilitate such NBIoT communications may be provided by a solar cell or other structure configured to convert solar radiation into electrical energy. For one or more embodiments, batteries, capacitors, inductors and/or other energy storage technologies may be used to power a sensor 102 and facilitate both the monitoring to temperatures for a member as well as facilitating communications between a sensor 102 and a communications device 104. Further, for at least one embodiment, the first link 103 may be used to provide simplex, half-duplex, full-duplex, or other communications link capabilities. It is to be appreciated that NBIoT technologies may be configured to provide low bandwidth, high latency (as measured in terms of one or more minutes lapsing between a sending of a message and receipt of a reply), and small data packages (i.e., data packets contain less than ______ data bits of payload data). Likewise, for at least one NBIoT technology configured for use with one or more embodiments of the present disclosure, operational constraints may include coverage constraints, such as less than 70% of a given defined total coverage area, limitations on mobile device usage, as may affect cars, RV, trucks and other vehicles, limits on and/or preclusion of cellular hand-offs between towers, and interference considerations arising between other structures, landscape and/or otherwise.

In another embodiment, one or more of the communications device(s) 104 may be configured as an NBIoT device. For such an embodiment, one or more sensors 102a n may be simple passive devices that communicate temperature readings on a given interval to the NBIoT device, as desired for the given embodiment. The NBIoT configured communications device 104 may be further configured to monitor the one or more received temperature readings, as provided by the one or more sensors 102, and take a desired action based thereon. For example, a NBIoT configured communications device 104 may be configured to send a message to a desired recipient when a temperature reading rises above or below a given threshold. Similarly, a NBIoT configured communications device 104 may be configured to send a message to a desired recipient when a rate of change in temperature exceeds a given threshold over a given period of time. For example, a faster than expected heating or cooling on a sun surface, as detected by one or more sensors 102, may result in a message being sent by a communications device 104 even though a pre-set temperature threshold has not been reached. Likewise, for at least one embodiment, predictable and/or gradual temperature changes in a sun surface, as might be expected to occur with the passing of a day, may not result in a message being sent until pre-set temperature limits are reached.

It is to be appreciated that the capabilities described above of a NBIoT configured sensor and/or NBIoT configured communications device may also be provided in wideband device configurations and other non-IOT configurations. But, by using IOT and related technologies, a system 100 may be configured to support the use of multiple, including hundreds if not thousands, of separately addressable IOT sensors and/or IOT communication devices. It is to be appreciated that such individual addressability is not commonly available using non-IOT communications technologies due to bandwidth and other well-known constraints. Accordingly, the use of IOT type devices as either and/or both of sensors 102 and communications device 104 facilitate the use of array's device configurations capable of measuring, tracking, reporting and reacting to temperatures changes across numerous portions of a sun surface and/or numerous sun surface areas associated with a given structure, such as on roofs, sides, windows, and other portions of a building.

As further shown in FIG. 1, the one or more communications devices 104 may be communicatively coupled by one or more second links 106a/106b/106n to a network system 108. The network system 108 may be provided by an operator providing a monitoring service or may be provided by a web server. For at least one embodiment, the network system 108 may include use of the Internet. A third link 110 may be used to further communicatively couple a communications device 104 with a remote control system 112, via the network system 108. It is to be appreciated that cellular technologies, such as those providing 3G, 4G, or 5G capabilities, wired networks, such as those provided by cable, telephone and other system operators, radio frequency, such as those provided by satellite and others, combinations of the foregoing, and/or the use of any networking and/or communications technologies and/or combinations thereof may be utilized to communicatively couple a given communications device 104 with one or remote control system(s) 112 via a network system 108 and one or more second links 106 and one or more third links 110.

For at least one embodiment, a network system 108 may not be utilized. Instead communications may be provided directly between a communications device 104 and a local control system 114. Any desired form of direct communications technologies may be used including, but not limited to, wired, wireless and combinations thereof. For examples, one or more communications devices 104 may be communicatively coupled to a local control system 114 by one or more fourth links 113, as shown by fourth link 113a/113b and 113n. Such fourth links 113, for example, may be provided by use of a local area network and related technologies, such as WiFi. For other embodiments, short range communications technologies such as Bluetooth and/or others may be utilized to communicatively couple a communications device 104 to a local control system 114.

Further, for at least one embodiment the system 100 may include use of each of the second link(s) 106, third link 110, and fourth link(s) 113. That is, for at least one embodiment, a communications device 104 may be configured to communicate with one or more of a local and/or remote systems. Such communications need may arise, for example, when messaging to a centralized system provided by network system 108 and/or remote control system 112 is desired for tracking purposes, while messaging to a local control system 114 is desired for responsive purposes and control of one or more thermal regulation devices 118. Other purposes may arise and the various embodiments are not to be considered as being limited to any given protocol for messaging, connectivity scheme, communications technologies utilized, or otherwise.

As further shown in FIG. 1, the system 100 may include one or more fifth links 116a/116b configured to communicatively couple one or more of the remote control system 112 and/or the local control system 114 with one or more thermal regulation device(s) 118. The one or more fifth links 116 may be configured such that either of the remote control system 112 and/or the local control system 114 can control one or more thermal regulation devices 118. It is to be appreciated that such fifth links 116 may be desired to permit remote control when an operator is away from the structure, while permitting local control while the operator is present. Likewise, it is to be appreciated that such control systems 112/114 may provide for automated control, semi-automated control, and/or manual control.

Further, one or more thermal regulation devices 118 may be used in the system 100. Non-limiting examples of such devices include heating, ventilating and air conditioning (HVAC) systems and other active and passive devices. Non-limiting examples of such other active and passive devices include fans, such as ceiling, attic, window and other fans, vents such as attic, room and other vents, shades, such as window shades, patio shades, awnings, louvers and otherwise, and any other active or passive device or system configurable for use in regulating a temperature of a given area. It is to be appreciated that any type and/or combination of thermal regulation devices may be used in conjunction with the various embodiments of the present disclosure.

Last, as shown in FIG. 1 for at least one embodiment, a sixth link 120 may be provided between a remote control system 112 and a local control system 114. Such sixth link 120 may use any communications topology, be direct and/or indirect, and for at least one embodiment may include use of a network system 108. The sixth link 120 may facilitate any desired communication of data, control signals, messaging, alerts or otherwise between a remote system operator (which may or may not include and/or involve use of human operators) and a local control system (which likewise may or may not include or involve use of human operators).

One non-limiting embodiment of a use of an embodiment of the present disclosure may arise in the context of a building having an attic ventilation system. Such an attic ventilation system may include one or more active and/or passive thermal regulation devices, such as louvers and vents and fans, blowers and the like. For at least this embodiment, one or more sensors 102 may be configured to monitor temperatures of a given area of a roof surface. One or more data points may be used to determine actions for the system to take with respect to the one or more thermal regulation devices. Such one or more data points may be pre-set, real-time set, fixed, adjustable, or otherwise. As the sensed temperature of the roof (the sun surface) proceeds to increase and/or decrease (as the case may be) above and/or below such data points, a local control system 114 and/or a remote control system 112 may receive corresponding temperature readings from the sensor(s) 102, via the communications device(s) 104, and instruct the one or more thermal regulation device(s) 118 to take certain actions. For example, during a summer season, as a roof warms throughout the day, a first data point, such as a minimum temperature for which one or more attic vents are open may always be satisfied. Such a minimum temperature may be set, for example, at 10 degrees Celsius. A second threshold, such as one set at 30 degrees Celsius may result in the corresponding control system (local or remote) opening additional louvers, for example, those configured to vent an attic space on a non-solar exposed surface. A third threshold, such as one set at 50 degrees Celsius may result in activation of one or more attic fans, configured to actively cool an attic space by use of conduction. As the temperature of the roof (sun surface) cools during the evening, a corresponding deactivation of one or more of such thermal regulation devices occur. Further, as the sensed temperatures change, one or more messages may be provided to operators of either and/or both of the remote and local control systems. Such messages may include alerts indicating, for example, that active thermal regulation is not occurring. For example, an attic fan is not engaging when desired, a louvre's positioning is obstructed, and/or that other thermal regulation may be needed and/or is being engaged, such as the use of an HVAC system to cool a living space below a given attic. Further, the recording, reporting, collecting and monitoring of temperature conditions for a given sun surface may be used any data assessment purpose, such as determining extremely localized weather patterns and forecasts.

Similarly, and for at least one embodiment, sensors can be configured and positioned to monitor the performance of other heat emitting sources, and not just those impacted by solar radiation. For example, sensors positioned near furnace and fireplace flue pipes and chimneys may monitor for efficiencies, or decreases therein, of such system. Likewise, sensors configured and positioned near vent fans, such as those used in bathrooms, kitchens and otherwise, may be configured to monitor for inadvertent use, such as when one is left on for a longer than desired duration. It is to be appreciated that the temperature sensors 102 of the present disclosure may be used to detect, monitor and report on temperatures of any surface, including those arising within and outside of any given structure.

Further it is to be appreciated that the temperature sensors 102 may be positioned at any desired location. Temperatures sensed by such sensors 102 may occur by means of direct and/or indirect convection, conduction, radiation, or otherwise.

Messages sent by and between a communications device 104 and a local control system and/or a remote control system and between an operator, human or otherwise, may also include any data desired data format, communications topology, or otherwise. For examples, message to a human operator may include use of alphabetic characters, per a communications protocol, such as those sent via a text or SMS or similar messaging system. Messages to a non-human operator may include data based on a pre-determined communications protocol. Such messaging protocols may include the use of encryption technologies.

It is further to be appreciated that, in addition to and/or in lieu of the one or more sun surface temperature sensors 102 utilized in conjunction with at least one embodiment of the present disclosure, other forms of sensors may be utilized. Such other sensors may include, but are not limited to, roof impact sensors—such as those configured to detect hail, rain, and object impacts on a surface, lightning sensors, wind sensors, and other forms of sensors. The various embodiments of the present disclosure are not limited to the type, number or capabilities of sensors utilized, with each such sensor being communicatively coupled, via one or more communications devices, to a local and/or remote control system.

Further, one or more embodiments of the present disclosure may be used to provide information useful for other system and/or devices utilized in conjunction with a given structure. For example, sensors may be used in conjunction with solar systems to provide efficiency monitoring of the latter. Likewise, data provided by the one or more sensor may be used for any purposes such as for the purposes of monitoring product reliability, installation, optimization, or otherwise. For example, when a temperature sensor indicates increasing quantities of solar radiation being received by a given structure and a solar array or panel thereof does not operate in a corresponding manner (i.e., increased solar panel output as the sun impact angle thereon increases), such data points may be used by solar panel system operators to detect defects and/or deficiencies realized in a given solar panel and/or its placement, orientation angle, or otherwise.

For at least one embodiment, the temperature sensors 102 may be configured for environmental monitoring uses. Environmental monitoring via use of one or more sensors may be useful for identifying trends in localized weather patterns. When combined across a plurality of sensor location installations, such as those arising across multiple structures in a city, state, country or otherwise, sensor data may be useful for tracking, monitoring, predicting and otherwise responding to environmental changes on micro and macro geographic levels. For example, arrays of sensors 102 may be positioned throughout a forest to identify heat islands, where a higher potential for a fire starting may arise, versus other areas. Similarly, such sensors 102 may be configured to provide highly-localized, as defined by detecting temperature changes within a 10 feet radius, monitoring of forest fire conditions. That is, instead of firefighters having to rely on aerial, satellite or other heat mapping technologies to monitor the progression of a fire, one or more temperature sensors 102, with corresponding communications device 104, may be deployed before the anticipated path(s) of a fire, with reporting of temperature changes being correspondingly reported back to one or more fixed or mobile, ground or air based, receiving towers. Such one or more temperature sensors 102 being deployed, for example, on one or more structures.

Accordingly, it is to be appreciated that the various embodiments of the present disclosure provide for use of one or more temperature sensors and/or other sensors, associated communications devices such as those NBIoT compatible, and one or more local and/or remote control systems configured to provide alerts to operators and, for at least one embodiment, control active and/or passive thermal regulation devices associated with a given structure.

Accordingly, it is to be appreciated that the various embodiments of the present disclosure provide devices, systems, and methods which may be used in countless implementations, with countless types of structures, at any given time, and using any desired form of sensor, communications technology, networking technologies, control systems and/or regulation devices. Although various embodiments of the claimed invention have been described above with a certain degree of particularity, or with reference to one or more individual embodiments, those skilled in the art could make numerous alterations to the disclosed embodiments without departing from the spirit or scope of the claimed invention. The use of the terms “approximately” or “substantially” means that a value of an element has a parameter that is expected to be close to a stated value or position. However, as is well known in the art, there may be minor variations that prevent the values from being exactly as stated. Accordingly, anticipated variances, such as 10% differences, are reasonable variances that a person having ordinary skill in the art would expect and know are acceptable relative to a stated or ideal goal for one or more embodiments of the present disclosure. It is also to be appreciated that the terms “top” and “bottom”, “left” and “right”, “up” or “down”, “first”, “second”, “next”, “last”, “before”, “after”, and other similar terms are used for description and ease of reference purposes only and are not intended to be limiting to any orientation or configuration of any elements or sequences of operations for the various embodiments of the present disclosure. Further, the terms “coupled”, “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an embodiment of the present disclosure. Other embodiments are therefore contemplated. It is intended that all matter contained in the above description and shown in the accompanying drawings shall be interpreted as illustrative only of embodiments and not limiting. Changes in detail or structure may be made without departing from the basic elements of the invention as defined in the following claims.

Further, a reference to a computer executable instruction includes the use of computer executable instructions that are configured to perform a predefined set of basic operations in response to receiving a corresponding basic instruction selected from a predefined native instruction set of codes. It is to be appreciated that such basic operations and basic instructions may be stored in a data storage device permanently and/or may be updateable, but, are non-transient as of a given time of use thereof. The storage device may be any device configured to store the instructions and is communicatively coupled to a processor configured to execute such instructions. The storage device and/or processors utilized operate independently, dependently, in a non-distributed or distributed processing manner, in serial, parallel or otherwise and may be located remotely or locally with respect to a given device or collection of devices configured to use such instructions to perform one or more operations.

What is claimed is:

1. A monitoring system, comprising:
a first sensor configured to monitor a first condition of a given structure;
a first communications device, communicatively coupled to the first sensor, and configured to output a first message providing a status of the given structure; and
wherein the first communications device is configured to output the first message using a narrow band Internet of Things communications topology.

2. The monitoring system of claim 1, comprising:
a remote control system, communicatively coupled to the first communications device, configured to analyze the first message and based thereon take a first action.

3. The monitoring system of claim 2,
wherein the remote control system is directly communicatively coupled to the first communications device via the narrow band Internet of Things communications topology.

4. The monitoring system of claim 1,
wherein the first sensor and the first communications device are configured into a single integrated device.

5. The monitoring system of claim 1,
wherein the first action includes activation of a thermal regulation device.

6. The monitoring system of claim 1,
wherein the first sensor is a temperature sensor and the first condition is a temperature of a portion of the given structure.

7. The monitoring system of claim 6,
wherein the portion of the given structure is a tile of a roof of a building.

8. The monitoring system of claim 1, comprising
a second sensor configured to monitor a second condition of a second structure.

9. The monitoring system of claim 9, comprising:
a second communications device, communicatively coupled to the second sensor, configured to output a second message using the narrow band Internet of Things communications topology;
a remote control system, communicatively coupled to each of the first communications device and the second communications device, configured to analyze the first message and the second message and based thereon take a second action;
wherein the second structure is a solar panel mounted on the given structure;
wherein the second condition is an electrical output of the solar panel;
wherein the second message provides the electrical output of the solar panel;
wherein the second action is generation of an alert message when the electrical output of the solar panel is less than an expected electrical output in view of the first condition of the given structure.

10. The monitoring system of claim 9,
wherein the first condition indicates a rising temperature of a roof portion of the given structure; and
wherein the roof portion and the second structure are located on the given structure so as to have a substantially similar sun impact angles.

11. The monitoring system of claim 1, comprising:
a local control system, communicatively coupled to the first communications device, configured to analyze the first message and based thereon take a first action;
wherein the first action includes configuring an operating state of at least one of an active thermal regulation device and a passive thermal regulation device;
wherein an operating state of an active thermal regulation device includes an on state and an off state; and
wherein an operating state of a passive thermal regulation device include an open state and a closed state.

12. The monitoring system of claim 11,
wherein the active thermal regulation device comprises an attic fan configured, when in the on state, to vent an attic of the given structure; and
wherein the passive thermal regulation device comprises an attic vent, configured, when in the open state, to permit venting of the attic.

13. The monitoring system of claim 12, comprising:
a remote control system, communicatively coupled to the first communications device, configured to analyze the first message and based thereon take a second action.

14. The monitoring system of claim 13,
wherein the first sensor is a temperature sensor and the first condition is a temperature of a roof portion of the given structure
wherein the first message is periodically output by the first communications device as the temperature of the roof portion of the given structure changes;
wherein the second action includes communicating at least one alert message to an occupant of the given structure;
wherein the at least one alert message indicates that a third action is being implemented by the local control system in view of a current temperature of the roof portion of the given structure as reported in a currently received first message; and
wherein the remote control system instructs the local control system to implement the third action.

15. The monitoring system of claim 14,
wherein the third action involves one of activation or deactivation of an HVAC system for the given structure.

16. A method for monitoring progression of a forest fire, comprising:
deploying a plurality of sensors proximate to a forest fire;
wherein each of the plurality of sensors are configured to read and report on a current environmental condition;
deploying at least one receiving station; and
monitoring, at a remote control system, each report of the current environmental condition by each of the plurality of sensors;
wherein each of the plurality of sensors includes a narrow band Internet-of-Things communications capability;
wherein each of the plurality of sensors are communicatively coupled to the at least one receiving station using the narrow band Internet-of-Things communications capability;
wherein the at least one receiving station is communicatively coupled to the remote control station; and
based on reported current environmental readings reported by each of the plurality of sensors, predicting future progression of the forest fire.

17. The method of claim 16,
wherein the environmental condition indicates at least one of a current temperature, dew point, humidity, and moisture content of a given portion of a landscape proximate to the forest fire.

18. An Internet-of-Things device comprising:
a first sensor configured to monitor a first condition;
a first communications device configured to report the first condition to at least one of remote control system and a local control system; and
wherein the first communications device is configured to report the first condition using a narrow band Internet-of-Things communications technology.

19. The Internet-of-Things device of claim 18,
wherein the first condition is a temperature of a portion of a roof for a given structure;
wherein the first sensor is a temperature sensor; and
wherein the first condition includes a temperature reading by the first sensor that exceeds a given threshold.

20. The Internet-of-Things device of claim 19, comprising:
a second sensor configured to monitor a second condition;
wherein the second condition is an impact of an object upon the portion of the roof for the given structure; and
wherein the first communications device is further configured to report the second condition to the remote control system for further reporting of the second condition by the remote control system in an alert message when the monitored second condition exceeds a given threshold.
